(19) United States
(12) Patent Application Publication
(10) Pub. No.: US 2021/0236963 A1
(43) Pub. Date: Aug. 5, 2021

(54) APPARATUS FOR SEPARATION OF PARTICULATE MATTER FROM FLUID

(71) Applicant: NCH Corporation, Irving, TX (US)

(72) Inventor: Michael J. Schuster, Shorewood, IL (US)

(21) Appl. No.: 17/168,424

(22) Filed: Feb. 5, 2021

Related U.S. Application Data
(60) Provisional application No. 62/970,527, filed on Feb. 5, 2020.

(51) Int. Cl. B01D 21/00; B01D 21/24; C02F 1/00; B08B 3/02; B08B 3/14

(52) U.S. Cl. CPC B01D 21/0042; B01D 21/245; B01D 21/0018; C02F 1/00; B08B 2203/027; B08B 3/14; B01D 21/2444; C02F 2001/007; B08B 3/026

(57) ABSTRACT

Various examples are provided for systems and apparatus for separation of particulate matter from fluid. In one example, an apparatus has a first wall and a second wall connected to and separated by an end edge wall and one or more side edge walls. The first wall has a fluid outlet. The apparatus has a separation chamber with a volume defined by the first wall, the second wall, the end edge wall, and the one or more side edge walls. Each of the side edge walls extends from a respective end of the end edge wall. The side edge walls taper from the end edge wall to a fluid exchange port, to guide contaminants or other particulate matter out the fluid exchange port.

### CROSS-REFERENCE TO RELATED APPLICATIONS

This application claims the benefit of, and priority to, U.S. Provisional Application No. 62/970,527 filed Feb. 5, 2020, the entire contents of which is hereby incorporated herein by reference.

### BACKGROUND

Water or cleaning fluid can be applied to a mechanical part using a high-pressure nozzle of a parts cleaning system to wash dirt, oil, grease, and other contaminants from mechanical parts that have been removed from devices, such as construction equipment. The cleaning fluid can include abrasive media, detergent powder, or other media encapsulated in a carrier such as water. Applying cleaning fluid to the part can result in any number of undesirable outcomes, including a portion of the media remaining on the part and rendering it potentially unsuitable for its intended purpose, or the cleaning fluid mixing with the contaminants and generating potentially hazardous waste.

### BRIEF DESCRIPTION OF THE DRAWINGS

Many aspects of the present disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 is a front view of an example of a parts cleaner and a separation device according to an aspect of the present disclosure.

FIG. 2 is a cutaway perspective view of an example of a system having the parts cleaner and the separation device of FIG. 1 in accordance with various embodiments of the present disclosure.

FIG. 3 is a detail view of a system having the parts cleaner and the separation device of FIG. 1 in accordance with various embodiments of the present disclosure.

FIG. 4 is a perspective view of the separation device of FIG. 1 in accordance with various embodiments of the present disclosure.

FIG. 5 is a perspective view of a first wall of the separation device of FIG. 1 in accordance with various embodiments of the present disclosure.

FIG. 6 shows respective views of an end edge wall, first wall, and a fluid exchange port of the separation device of FIG. 1 in accordance with various embodiments of the present disclosure.

FIG. 7 is a detail view of another example of a system having the parts cleaner and the separation device of FIG. 1 in accordance with various embodiments of the present disclosure.

FIG. 8 is a perspective view of the separation device of FIG. 7 in accordance with various embodiments of the present disclosure.

FIGS. 9A, 9B, and 9C are respective views of the wall, the side edge wall, and the fluid exchange ports of the separation device of FIG. 8 in accordance with various embodiments of the present disclosure.

FIG. 10 is a perspective view of another example of a separation device of FIG. 1 in accordance with various embodiments of the present disclosure.

FIG. 11 is a perspective view of the separation device of FIG. 10 in accordance with various embodiments of the present disclosure.

FIGS. 12A and 12B are respective views of a wall and a cutaway of a wall of the separation device of FIG. 10 in accordance with various embodiments of the present disclosure.

### DETAILED DESCRIPTION

Disclosed herein are various examples related to systems, apparatus, and devices for separation of particulate matter from fluid. Reference will now be made in detail to the description of the embodiments as illustrated in the drawings, wherein like reference numbers indicate like parts throughout the several views.

Various systems exist for washing or cleaning mechanical parts that have been removed from devices such as construction equipment. In some parts cleaners or parts cleaning systems, a part is loaded onto a tray and a lid is closed. Through integrated gloves, an operator can hold the part and a nozzle, while activating a switch to cause a jet of high-pressure cleaning fluid to be pumped from a reservoir and directed towards the part to be cleaned. An air compressor (not shown) can provide air pressure to increase cleaning performance and pressure. Cleaning fluid can include abrasive beads, detergent powder, or other media encapsulated in a carrier such as water. After being directed towards the part to be cleaned, the cleaning fluid can become mixed with dirt, oil, grease, and other contaminants that washes off the part, such as by dropping through holes in the tray and into the reservoir.

A parts cleaning system can be described as an open-loop system or a closed-loop system depending on how potentially contaminated fluid flows through the system. In an open-loop system, the parts cleaning system can include a drain line and a water line. Fluid that returns to the reservoir (e.g., washing off the part) can recirculate contaminated fluid through the parts cleaning system, or run the potentially contaminated fluid down the drain. In a closed-loop system, the fluid can be run through a filtration process before recirculating it back into the parts cleaning system. Closed-loop systems can include evaporators, neutralizers, and oil skimmers, which can include outside-the-cabinet devices that require frequent checks and maintenance.

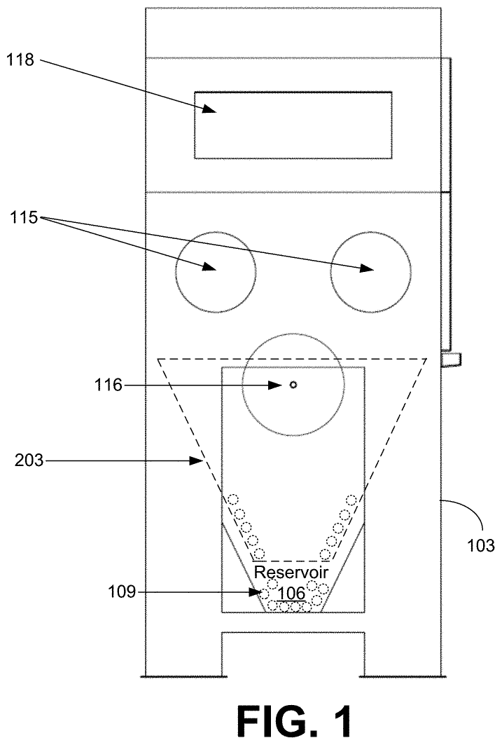

Turning to FIG. 1, shown is a front view of a parts cleaner 103 that has a reservoir 106 for holding cleaning fluid or other fluid to be recirculated by the parts cleaner 103. The reservoir 106 can contain a slurry 109 of water, media, and contaminants. The reservoir 106 has a lower fluid outlet (not depicted) through which the slurry 109 or other fluid can be pumped out of the reservoir 106 to a nozzle for purposes of parts cleaning. The slurry 109 can include glass bead, ceramic beads, brown fused alumina, black fused alumina, white fused alumina, garnet, black silicon carbide, green silicon carbide, steel grit, steel shot, aluminum cut wire, stainless cut wire, stainless steel cut wire, zinc cut wire, copper cut wire, copper slag, powder with a size on a microgrit scale, 9-13 micrometer glass beads, 70 grit steel shot, and other particulate matter that promotes cleaning and is suitably small to pass through the lower fluid outlet of the reservoir 106.

The parts cleaner 103 has two holes 115 through which an operator can insert his or her hands into integrated gloves for manipulating the part, or the nozzle or other components associated with the parts cleaner 103. There is also a viewing window 118 for observing the parts cleaning process. The parts cleaner 103 also includes a hole 116 to accommodate an upper fluid outlet (not shown) from the separation device 203 as will be described.

An operator can activate a switch to cause a jet of fluid (media encapsulated in water, slurry 109, etc.) pumped from the reservoir 106 and high pressure air directed out of a nozzle (not shown) and directed towards the part to be cleaned. The viewing window 118 can become fogged or dirty, for example, due to fluid drops and particulate matter coming into contact with the viewing window 118. Dirt, oil, grease, and other contaminants washing off the part can enter the reservoir 106, making it difficult to use the fluid (e.g., slurry 109) in the reservoir 106 alone to clean media or contaminants off the part, internal cabinet, or to clean the viewing window 118.

According to various embodiments described herein, a separation device 203 is placed in the reservoir 106. The separation device 203 includes an upper fluid outlet (not shown) having a fluid output port. The slurry 109 enters the separation device 203 through one or more fluid exchange ports of the separation device 203 and into a separation chamber of the separation device 203 as will be described in further detail with reference to later figures.

The separation device 203 can be isosceles-trapezoidedly shaped, or a shape of some other two- or three-dimensional figure that has appropriate surfaces or elements for guiding particulate matter as will be described. In one embodiment, the slurry 109 comes in contact with one or more side edge walls that are adapted to guide contaminants of the slurry 109 out through the fluid exchange port. The side edge walls, or other components of the separation device 203, settle out the contaminants according to one or more properties or combination of properties of the contaminants. The contaminants are guided out of the fluid exchange port according to weight, density, size, shape or other properties to create a region of semi-filtered water in the separation device 203.

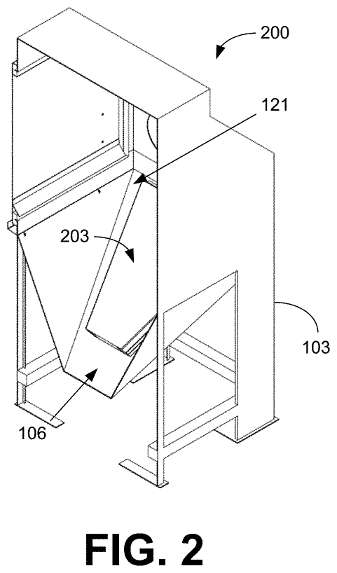

Referring now to FIG. 2, shown is a cutaway perspective view of an example of a system 200 having the parts cleaner 103 and the separation device 203 of FIG. 1 in accordance with various embodiments of the present disclosure. The parts cleaner 103 is merely an example of an environment in which the separation device 203 can be used.

Various elements of the parts cleaner 103, the reservoir 106, etc., have been cut away, thereby revealing that one or more sides of the reservoir 106 can be tapered or sloped. According to one embodiment, the separation device 203 rests at an angle on an interior surface 121 of the reservoir 106. According to the various embodiments, the separation device 203 is positioned so that gravity assists in causing heavier particulate matter that is inside the separation device 203 to fall in a desired direction as will be described.

Disclosed herein are various examples of a separation device 203 that can be located, fastened, removably fastened, placed, seated, etc., against the interior surface 121 of the reservoir 106. In one embodiment, the separation device 203 hangs inside or is placed or affixed within or as part of the reservoir 106 below the water level to create a dead zone relative to circulating slurry 109 inside the reservoir 106. The separation device 203 comprises, for example, a separation chamber, which will be described in more detail with reference to the figures below.

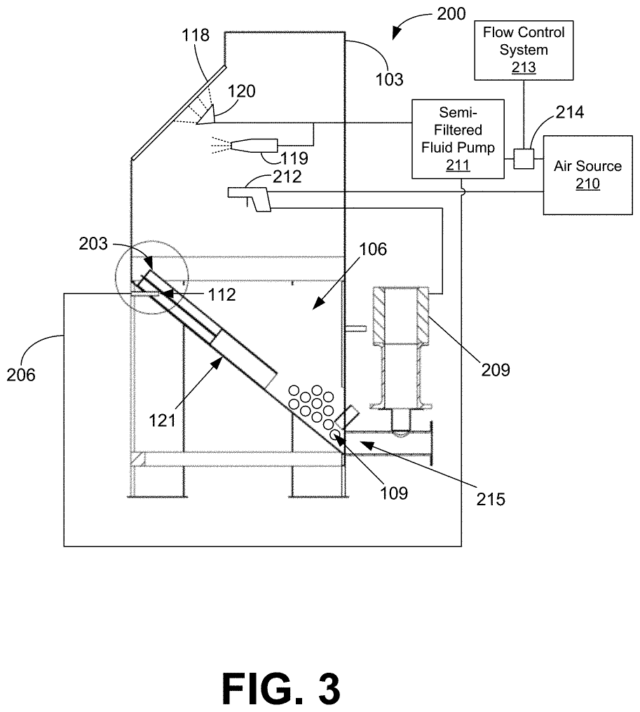

FIG. 3 shows a detail view of a system 200 having the parts cleaner 103 and the separation device 203 of FIG. 1 in accordance with various embodiments of the present disclosure. The separation device 203 includes a wall with a hole to accommodate the upper fluid outlet 112 from the separation device 203. According to one embodiment, the hole is of suitable size and shape to allow a pipe to pass therethrough so as to position the upper fluid outlet 112 in the upper portion of the separation device 203. A seal is formed between the exterior of the pipe and the wall of the reservoir 106 with a weld or other type of seal so that contents of the reservoir 106 or the separation device 203 do not leak out of the parts cleaner 103. According to one embodiment, the upper fluid outlet 112 provides fluid communication between the separation device 203 and a semi-filtered fluid pump 211. The output of the semi-filtered fluid pump 211 is channeled through a pipe and/or hose to a spray apparatus 119 inside a cabinet of the parts cleaner 103. In operation, the spray apparatus 119 can be directed (e.g., by hand) towards the part to be cleaned, towards an inside surface of the cabinet, or towards the viewing window 118.

The parts cleaner 103 includes a media pump 209 that is used to pump the slurry 109 or other media in the parts cleaner 103. The media pump 209 has an inlet that is in fluid communication with a lower fluid outlet 215 of the reservoir 106. The outlet of the media pump 209 is connected to the nozzle 212 by way of a pipe and/or hose to supply slurry 109 or other fluid media to the nozzle 212 for parts cleaning. A portion of the output of the media pump 209 can also be directed through a hose or pipe back into the reservoir 106 to agitate the slurry that sits in the reservoir 106 so that the slurry 109 that is provided to the nozzle 212 is uniform as can be appreciated.

The nozzle 212 also includes a second inlet to receive compressed air from an air source 210, where the air source comprises, for example, an air compressor to increase cleaning performance and pressure. The cleaning slurry 109 and compressed air are provided to the nozzle 212 so that the slurry 109 may be ejected with force against a part to be cleaned to facilitate the cleaning function as can be appreciated. The semi-filtered fluid pump 211 is in fluid communication with the upper fluid outlet 112 positioned within the separation device 203. The semi-filtered fluid pump 211 may comprise an electric or pneumatic pump that pulls fluid from the upper fluid outlet 112 and provides pressurized, semi-filtered water to the spray apparatus 119 to rinse a part off, or to clean the inside surface of the cabinet or other area of the parts cleaner 103. The output of the semi-filtered fluid pump 211 may also be applied to a spray head 120 or other device that directs the semi-filtered water to the window 118 to clean the window 118. Alternatively, the window 118 may also be cleaned by directing compressed air thereto.

The separation device 203 is depicted as having a wall that rests against an interior surface 121 of the reservoir 106. The upper fluid outlet 112 positioned in the separation device 201 is connected to a hose 206 or other line. This hose 206 is, in turn, coupled to an inlet of the semi-filtered fluid pump 211. The hose 206 may comprise a flexible hose, rigid pipe, or other type of tube. In one embodiment, the hose 206 from the separation device 203 is coupled to the semi-filtered fluid pump 211 to pull water from the separation device 203 and provide semi-filtered water to spray apparatus 119 and/or the spray head 120. The semi-filtered fluid pump 211 may be driven by air (pneumatic) or electricity as can be appreciated. The spray apparatus 119 may comprise, for example, a spray nozzle such as can be attached to a garden hose. Alternatively, the hose 206 may terminate into an open end in the parts cleaning device, where a spray apparatus 119 is not used. The spray apparatus 119 can be directed (e.g., by hand) towards the part to be cleaned, the viewing window 118, or the interior surface of the cabinet of the parts cleaner 103, etc., to remove residual cleaning media.

In an alternative embodiment, a multi-port valve or other fluid control device may be provided that gives alternate paths of fluid flow to the nozzle 212. Such a multi-port valve would include a first inlet connected to the outlet of the media pump 209, and a second inlet connected to the upper fluid output 112. Such a multi-port valve also comprises an outlet connected to the nozzle 212. The multi-port valve may selectively allow the slurry 109 from the reservoir 106 or the semi-filtered water from the separation device 203 to be applied to the nozzle 212 so that the spray apparatus 119 is unnecessary. In this respect, one may switch such a multi-port valve between the slurry 109 and the semi-filtered water from the separation device 203 as desired, although one may wish to purge the line of leftover slurry/semi-filtered water after making the switch from one to the other as can be appreciated.

The system 200 includes a flow control system 213 that controls the operation of the semi-filtered fluid pump 211 according to an embodiment of the present disclosure. The flow control system 213 is electrically coupled, for example, to a solenoid valve 214 that controls whether pressurized air is supplied to the semi-filtered fluid pump 211 in the case that the semi-filtered fluid pump 211 is a pneumatic pump driven by compressed air. Alternatively, the semi-filtered fluid pump 211 may be driven by electricity, where the flow control system 213 may include a solenoid or relay switch to turn power on or off to the semi-filtered fluid pump 211. The flow control system 213 may include a pushbutton, switch, or other control component that causes the flow control system 213 to direct the semi-filtered fluid pump 211 to pump fluid from within the separation device 203 to the spray apparatus 119, the spray head 120, or other device. Alternatively, there may be a hose with an open end that extends from the semi-filtered fluid pump 211 as mentioned above.

According to various embodiments, the flow control system 213 controls when the semi-filtered fluid pump 211 is allowed to turn on or off to ensure that the semi-filtered water that is pulled from the separation device 203 in such a manner that allows particulate matter to separate from the fluid so that slurry 109 is not pulled through the hose 206. That is to say, the separation device 203 provides for a separation chamber of stagnant fluid that is subjected to a reduced amount of agitation relative to the rest of the reservoir 106. Given the still nature of the fluid within this separation chamber, heavier particles will fall toward the bottom of the separation device 203 and will exit the same through fluid exchange ports as will be described. Thus, the fluid that is toward an upper end of the separation device 203 will have less particulate matter in it and can be used for rinsing parts, the window 118, and the interior of the parts cleaning machine 103. If fluid is drawn from the separation chamber defined by the separation device 203 at too fast a rate, then slurry 109 will be pulled into the separation chamber through fluid exchange ports and the resulting agitation will defeat the process of gravitational separation of particulate matter from the fluid.

To ensure this does not happen, the flow control system 213 controls how long the semi-filtered fluid pump 211 is operated so that proper separation of particular matter from the fluid occurs in the separation chamber defined by the separation device 203. In one example embodiment, the semi-filtered fluid pump 211 is switched on and off for predefined periods of time to allow the gravitational separation to occur such that the fluid pumped from the separation device 203 has an acceptable reduced amount of particulate matter. Alternatively, the semi-filtered fluid pump 211 may be specified so that the maximum fluid flow that can be achieved would not cause undue agitation in the separation chamber of the separation device 203 that will defeat the purpose of the separation device 203. Still further, the spray apparatus 119 may include a nozzle with a predefined orifice that restricts the flow therethrough to prevent undue fluid flow from the separation device 203. In addition, other approaches may be employed to ensure that the fluid flow from the separation device 203 does not cause the undue agitation of the fluid within the separation chamber of the separation device 203.

The system 200 may comprise a closed-loop system that includes the parts cleaner 103 or other open-loop or recirculating parts cleaners. As mentioned above, the separation device 203 is submerged in a reservoir 106 that contains a slurry 109 of water, media, and contaminants. The separation device 203 provides for semi-filtered fluid that can be used for the various purposes as mentioned above. The system 200 can provide semi-filtered water to a parts cleaner 103 (e.g., one that would normally require a water line and drain) to convert the parts cleaner 103 from an open-loop system into a closed-loop system that can operate without a drain line and a water line.

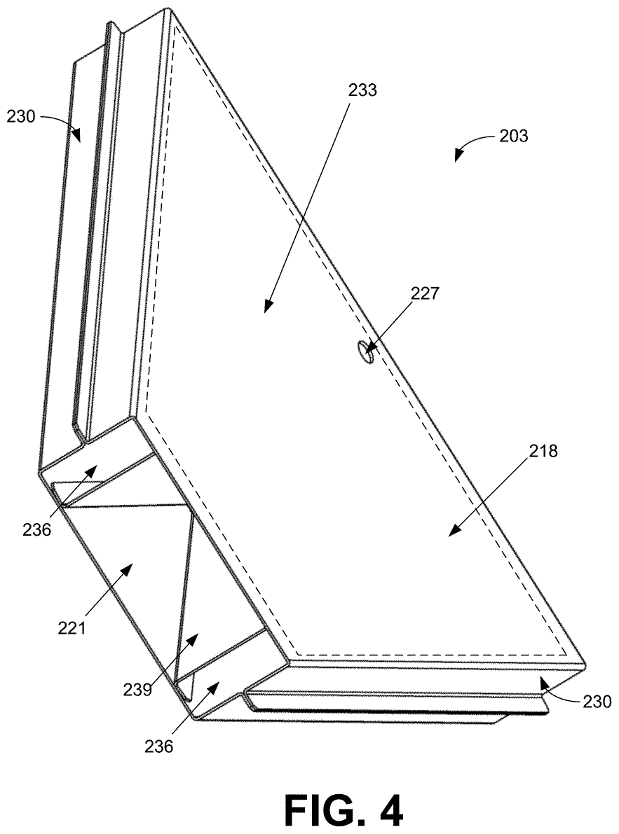

Moving on to FIG. 4, shown is a perspective view of the separation device 203 of FIG. 1 in accordance with various embodiments of the present disclosure. The separation device 203 includes a first wall 218 and a second wall 221 connected to and separated by an end edge wall. In some examples, the first wall 218 and the second wall 221 include one or more side edge walls 230. In other examples, one or more side edge walls 230 are connected to the first wall 218 and the second wall 221. The side edge walls 230 also separate the first wall 218 and the second wall 221 from each other such that the first wall 218 and the second wall 221 are substantially parallel to each other.

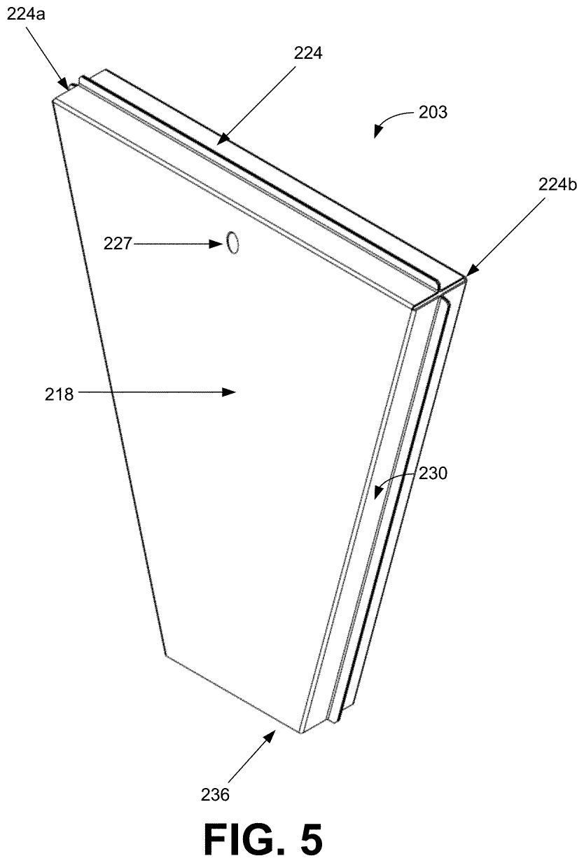

The first wall 218 has an exit port 227. The exit port 227 can for example be a hole that is sized and shaped to accommodate a pipe that provides for the upper fluid outlet 112 (FIG. 3) of the parts cleaner 103 (FIG. 3). Alternatively, the upper fluid outlet 112 may be flush with the exit port 227 without a pipe extending therethrough. The separation device 203 comprises a separation chamber 233 having a volume defined by the first wall 218, the second wall 221, the end edge wall 224 (FIG. 5), and the side edge walls 230. The separation chamber 233 can be isosceles-trapezoidedly shaped, or a shape of some other two- or three-dimensional figure that has appropriate surfaces or elements for guiding particulate matter, as will be described with regard to operation of the separation device 203 below.

Each of the side edge walls 230 extends from a respective end of the end edge wall (not shown), and tapers from the end edge wall 224 to a fluid exchange ports 236. A wedge 239 is disposed within the separation chamber 233 and connected to at least one of the first wall 218 and the second wall 221 adjacent to at least one fluid exchange port 236. In some examples, the fluid exchange port 236 includes multiple fluid exchange ports separated by or defined by the wedge 239, the first wall 218, the second wall 221, and the plurality of side edge walls 230. The wedge 239 can be positioned so that the narrow end of the wedge 239 is directed toward the end edge wall 224. In some embodiments, a closed end of the wedge 239 terminates into a peak to prevent buildup of contaminants on the wedge 239 itself. One or more components of the separation device 203 are adapted to guide contaminants of the slurry 109 (FIG. 3), particulate matter, or other things, out of at least one fluid exchange port 236.

In operation, a pump, such as the semi-filtered fluid pump 211 depicted in FIG. 3, pulls fluid contained in the separation chamber 233 through the upper fluid outlet 112 as described above. As fluid is pulled out of the separation chamber 233 by the semi-filtered fluid pump 211, the slurry 109 of water, media, and contaminants, from the reservoir 106 is pulled in through the fluid exchange port(s) 236 and into the separation chamber 233 of the separation device 203. Heavier particles in the slurry will then fall to the bottom of the separation chamber 233 and the side edge walls 230 will guide such contaminants of the slurry 109 out through the fluid exchange port 236. In this manner, the separation device 203 can create a region of semi-filtered water in the separation chamber 233. As mentioned above, care is taken to ensure that the semi-filtered fluid is not pulled out of the separation chamber 233 at too high a rate to prevent agitation of the fluid in the separation chamber 223 and potentially interfering with the gravitational separation of particulate matter from the fluid. By operation of the semi-filtered fluid pump 211, the separation device 203 can then provide semi-filtered water through the upper fluid outlet 112.

FIG. 5 shows a perspective view of a first wall 218 of the separation device 203 of FIG. 1 in accordance with various embodiments of the present disclosure. The first wall 218 has the exit port 227 that accommodates the upper fluid outlet 112 (FIG. 3) for pulling fluid from the separation chamber 233 (FIG. 4). In the example of FIG. 5, there is an end edge wall 224 that is connected between the first wall 218 and second wall 221. The end edge wall 224 is depicted with ends 224a and 224b. Side edge walls 230 extend from a respective ends 224a and 224b of the end edge wall 224. The side edge wall 230 tapers from the end edge wall 224 to at least one fluid exchange port 236.

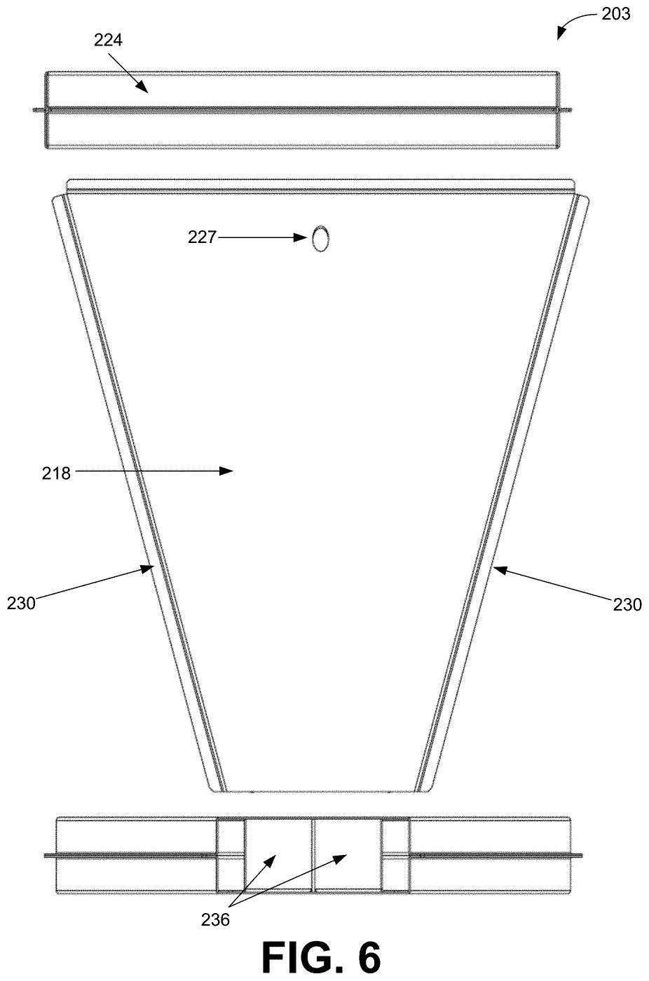

FIG. 6 shows respective views of an end edge wall 224, first wall 218, and fluid exchange ports 236 of the separation device 203 of FIG. 1 in accordance with various embodiments of the present disclosure. The hole 227 accommodates the upper fluid outlet 112. FIG. 6 shows an example of the separation device 203 that is shaped like an isosceles-trapezoid and has side edge walls 230 with the same length.

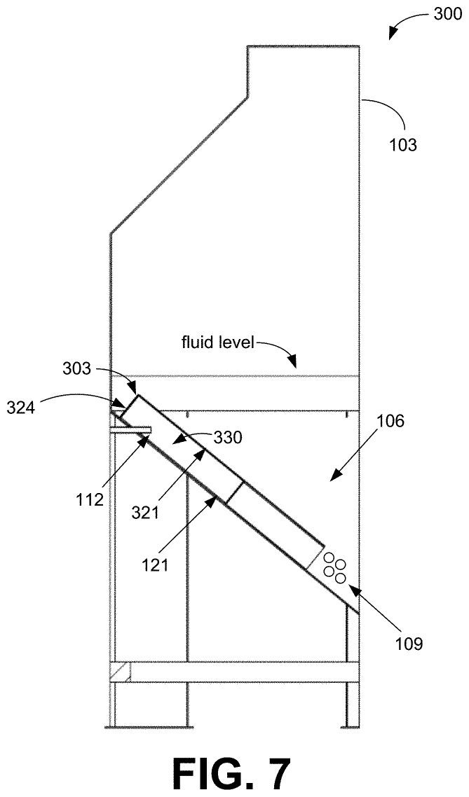

Turning to FIG. 7, shown is a detail view of a system 300 having the parts cleaner 103 and another example of a separation device 303 of FIG. 1 in accordance with various embodiments of the present disclosure. The separation device 303 has a wall 321 having an end wedge wall 324 and side edge walls 330 extending therefrom, where the end wedge wall 324 and the side edge walls 330 are substantially perpendicular to the wall 321, although in other embodiments they may be positioned at another angle relative to the wall 321. The free edges of the end edge wall 324 and the side edge walls 330 seat against the interior surface 121 of the reservoir 106. The wall 321, end edge wall 324, side edge walls 330, and the interior surface 121 of the reservoir 106 define a separation chamber having a volume, such as a void volume space for containing fluid. The separation device 303 can be placed within or affixed within the reservoir 106 such that the upper fluid outlet 112 is below a level of water or other fluid in the reservoir 106. The upper fluid outlet 112 is ported through the outer wall of the parts cleaner 103 as shown. As an alternative, it should be understood that the separation device 303 may be positioned against any wall of the reservoir 106 in a manner not shown in FIG. 7, or the separation device 303 may be suspended within the reservoir 106. Regardless of the arrangement, the separation device 303 is positioned such that the upper fluid outlet 112 is below a level of water or other fluid in the reservoir 106 so that fluid and not air is pumped by the semi-filtered fluid pump 211 as described above with reference to FIG. 3.

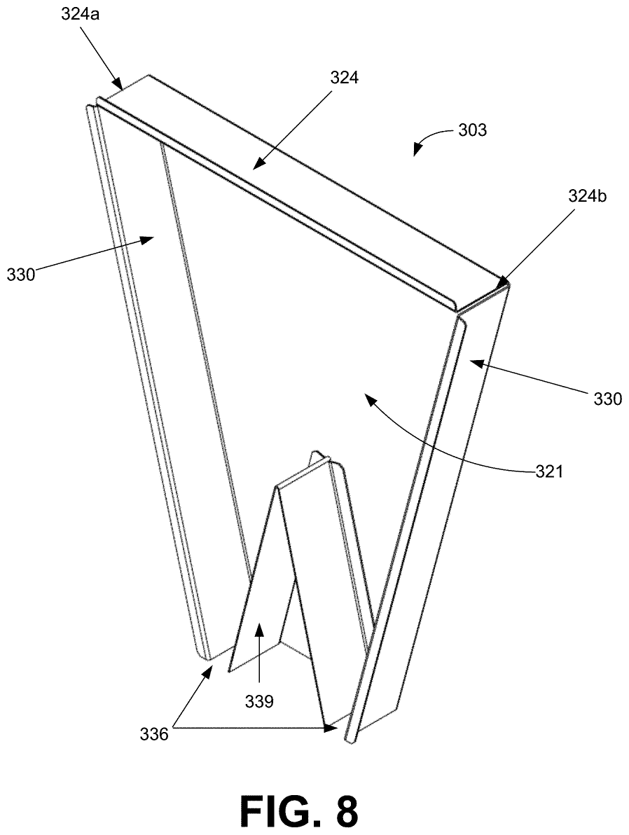

FIG. 8 shows a perspective view of the separation device 303 of FIG. 7 in accordance with various embodiments of the present disclosure. Each of the side edge walls 330 extends from a respective end 324a, 324b of the end edge wall 324. The side edge walls 330 taper from the end edge wall 324 to a fluid exchange port 336. The end edge wall 324 and the side edge walls 330 are adapted to rest against the interior surface 121 (FIG. 7) of the reservoir 106, for example as shown in FIG. 7.

When the side edge walls 330 and the end edge wall 324 are positioned or seated against the interior surface 121 of the reservoir 106 (e.g., as shown in FIG. 7), a separation chamber is provided with a volume defined by the wall 321, the interior surface 121, the end edge wall 324, and the side edge walls 330. FIG. 8 depicts that the separation device 303 can have a wedge 339 disposed within the separation chamber and connected to the wall 321 adjacent to the fluid exchange ports 336. In operation, seating the end edge wall 324 and the side edge walls 330 against the interior surface 121 of the reservoir 106 can place the separation chamber in fluid communication with the upper fluid outlet 112 depicted in FIG. 7.

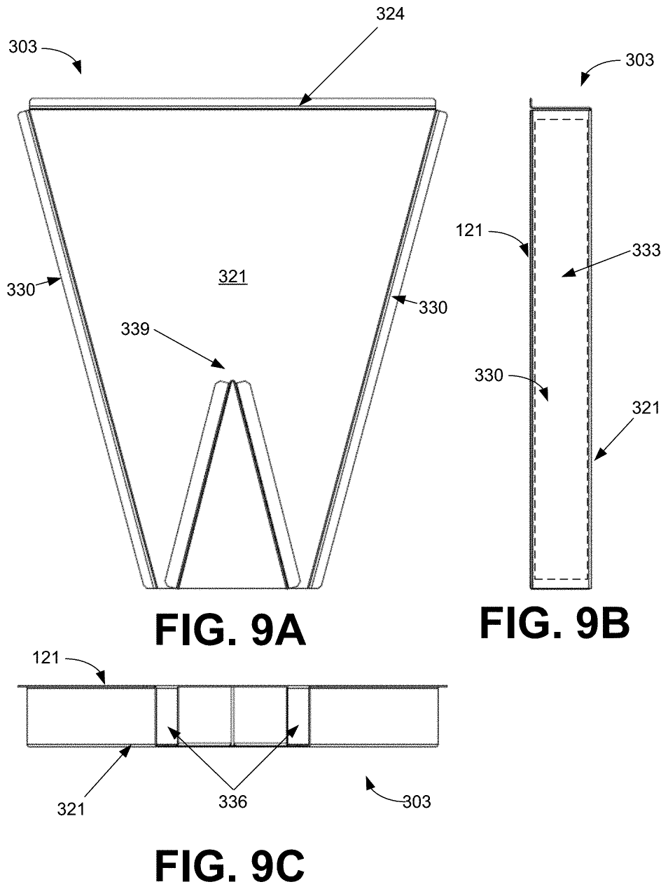

FIGS. 9A, 9B, and 9C are respective views of the wall 321, the side edge wall 330, and the fluid exchange ports 336 of the separation device 303 of FIG. 8 in accordance with various embodiments of the present disclosure. FIG. 9B depicts the separation device 303 with a separation chamber 333 that has, when the end edge wall 324 and the side edge walls 330 are positioned against an interior surface 121 as shown in FIG. 7, a volume defined at least by the wall 321, end edge wall 324, the side edge walls 330, and the interior surface 121. In such case, the end edge wall 324 and the side edge walls 330 may not be necessary where other walls that make up the reservoir 106 (FIG. 7) may be used and various mechanisms may be used to suspend the wall 321 a predefined distance from the interior surface 121. In some examples, the volume of the separation chamber 333 is defined by the wall 321, the end edge wall 324 (FIG. 8), the interior surface 121 (FIG. 7), and the side edge walls 330.

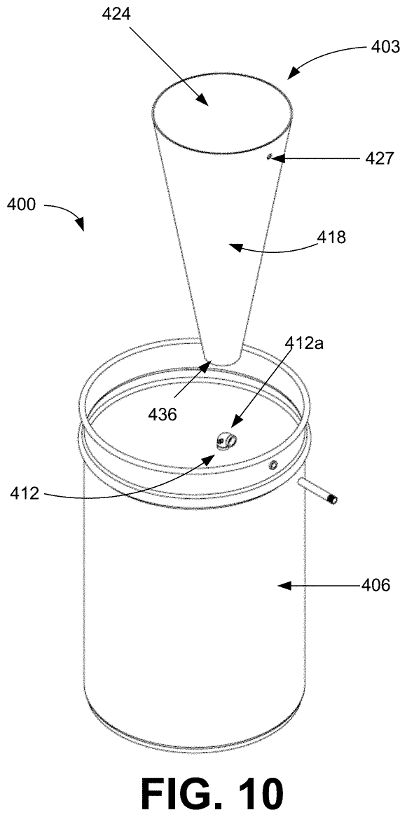

Turning to FIG. 10, shown is a perspective view of a system 400 with another example of a separation device 403 of FIG. 1 that is cone shaped in accordance with various embodiments of the present disclosure. As contemplated herein, the terms “cone shaped” can also mean frustoconical or being shaped like a frustrum of a cone. As shown, the cone is inverted. In the example of FIG. 10, the separation device 403 has a wall 418 that can guide contaminants of the slurry 109 (FIG. 1) out of the fluid exchange port 436. An end cap wall 424 closes the top of the cone shaped separation device 403. While the separation device 403 that is depicted as cone-shaped is shown as having the wall 418, the separation device 403 can also have one or more other elements that can form a cone shape, or part of a cone shape, such as the wall 221 described with reference to FIG. 4. For example, the wall 418 and the wall 221 can be shaped like a half of a frustrum of a cone so that when they are connected they form a cone shape. The wall 418 has an exit port 427 that is sized and shaped to receive a pipe that provides for the upper fluid outlet 412 of the reservoir 406. Although the exit port 427 is shown in the wall 418, it can be understood that such port 427 may be positioned on the end cap wall 424. The reservoir 106 can be a drum or other container suitable for holding cleaning fluid, media, water, or other fluids. A fitting 412a is removably fastened onto the pipe extending through the exit port 427. The wall 418, and/or other elements of the separation device 403, can define a volume of a separation chamber 433 for example as shown in FIGS. 4 and 9B.

In operation, the upper fluid outlet 412 is defined by a pipe connected to the fitting 412a. A pump, such as the semi-filtered fluid pump 211 depicted in FIG. 3, can pull fluid contained in the separation chamber 433 out through the upper fluid outlet 412. For example, the semi-filtered fluid pump 211 pulls semi-filtered fluid from the separation chamber, thereby drawing the slurry 109 of water, media, and contaminants, from the reservoir 106 through the fluid exchange port 436 and into the separation chamber of the separation device 403. The wall 418 or other elements of the separation device 403 can guide particles and contaminants of the slurry 109 (FIG. 1) out through the fluid exchange port 436 as such particles and contaminants fall due to gravity. The separation device 403 provides a region of semi-filtered water in the separation chamber. By operation of the semi-filtered fluid pump 211, the separation device 403 can then provide semi-filtered water for the various uses described above.

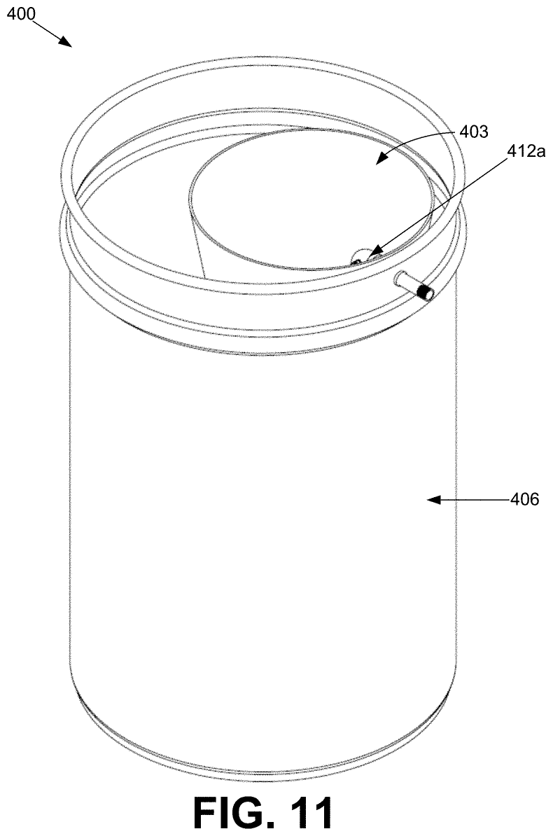

FIG. 11 is a perspective view of a system 400 having the separation device 403 of FIG. 10 in accordance with various embodiments of the present disclosure. The separation device 403 is inserted into the reservoir 406 and submerged in a slurry 109 (FIG. 1) of water, media, and contaminants, and the like. The reservoir 406 is in fluid communication with a media pump (not shown) that may draw slurry 109 from the bottom of the reservoir 106. To this end, the components of the parts washer that employ the separation device 403 and reservoir 406 are similar to those described with reference to FIG. 3.

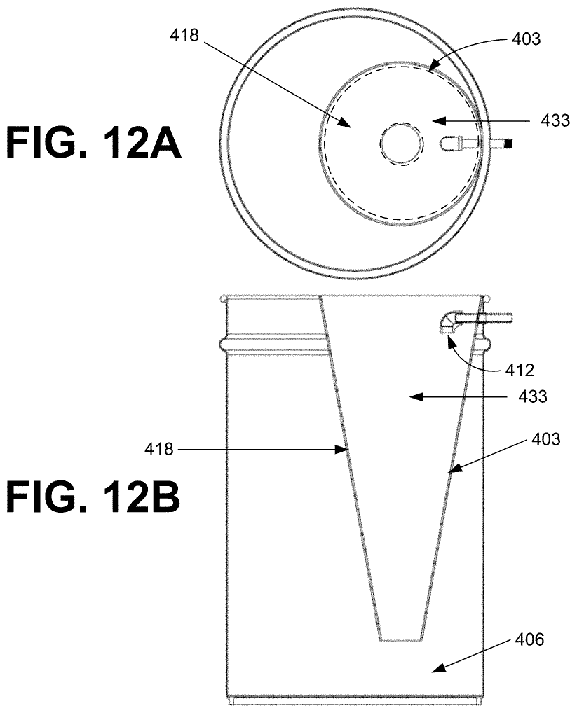

FIGS. 12A and 12B are respective views of a wall 418 and a cutaway of a wall 418 of a separation device 403 in accordance with various embodiments of the present disclosure. In FIG. 12A, the separation device 403 has created a region of semi-filtered water in the separation chamber 433. While the separation device 403 of FIG. 12A is depicted as not having a wedge or similar structure such as the wedge 239 of FIG. 4, the separation device 403 can have the wedge 239, an inverted cone, or other shaped element connected to the wall 418 that is adapted to prevent buildup of contaminants on itself. FIG. 12B depicts that it can be advantageous for the wall 418 to extend towards the bottom of the reservoir 406 and allow a distance between the bottom of the reservoir 406, such as would be suitable to prevent the separation device 403 from extending into a deposit or zone of media, containments, or other fluid that is not semi-filtered fluid.

It should be emphasized that the above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

It should be noted that ratios, concentrations, amounts, and other numerical data may be expressed herein in a range format. It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a concentration range of “about 0.1% to about 5%” should be interpreted to include not only the explicitly recited concentration of about 0.1 wt % to about 5 wt %, but also include individual concentrations (e.g., 1%, 2%, 3%, and 4%) and the sub-ranges (e.g., 0.5%, 1.1%, 2.2%, 3.3%, and 4.4%) within the indicated range. The term “about” can include traditional rounding according to significant figures of numerical values. In addition, the phrase “about ‘x’ to ‘y’” includes “about ‘x’ to about ‘y’”.

Therefore, the following is claimed:

1. An apparatus, comprising:
a first wall and a second wall connected to and separated by an end edge wall and a plurality of side edge walls;
a separation chamber having a volume defined by the first wall, the second wall, the end edge wall, and the plurality of side edge walls, the separation chamber having a fluid outlet; and
each of the side edge walls extending from a respective end of the end edge wall, the side edge walls tapering from the end edge wall to at least one fluid exchange port.

2. The apparatus of claim 1, further comprising a wedge disposed within the separation chamber between the first wall and the second wall and adjacent to the at least one fluid exchange port.

3. The apparatus of claim 2, wherein the at least one fluid exchange port comprises a plurality of fluid exchange ports defined by the wedge, the first wall, the second wall, and the plurality of side edge walls.

4. The apparatus of claim 2, wherein a closed end of the wedge terminates into a peak to prevent buildup of contaminants on the wedge.

5. The apparatus of claim 2, wherein a closed end of the wedge is directed toward the end edge wall.

6. The apparatus of claim 1, wherein the separation chamber is isosceles-trapezoidedly shaped.

7. The apparatus of claim 1, wherein the apparatus is adapted to be submerged in a slurry of water, media, and contaminants in a reservoir of a parts cleaner.

8. The apparatus of claim 7, wherein the plurality of side edge walls are adapted to guide the contaminants out of the at least one fluid exchange port.

9. The apparatus of claim 1, wherein the fluid outlet is in fluid communication with a pump.

10. The apparatus of claim 1, wherein the first wall is adapted to seat against an interior surface of a reservoir of a parts cleaner.

11. An apparatus, comprising:
at least one wall connected to an end edge wall and a plurality of side edge walls;
each of the side edge walls extending from a respective end of the end edge wall, the side edge walls tapering from the end edge wall to at least one fluid exchange port; and
a separation chamber having, when the plurality of side edge walls and the end edge wall are positioned against an interior surface of a reservoir of a parts cleaner, a volume defined by the at least one wall, the interior surface of the reservoir of the parts cleaner, the end edge wall, and the plurality of side edge walls.

12. The apparatus of claim 11, further comprising a wedge disposed within the separation chamber and connected to the at least one wall adjacent to the at least one fluid exchange port.

13. The apparatus of claim 11, wherein the end edge wall and the plurality of side edge walls are adapted to be received by corresponding elements on the interior surface of the reservoir.

14. The apparatus of claim 11, wherein the end edge wall and the plurality of side edge walls are adapted to seat against the interior surface of the reservoir.

15. The apparatus of claim 14, wherein seating the end edge wall and the plurality of side edge walls against the interior surface of the reservoir places the separation chamber in fluid communication with an upper fluid outlet of the reservoir.

16. A system, comprising:
a parts cleaner comprising a reservoir; and
a separation device in the reservoir and seated against an interior surface of the reservoir, the separation device comprising:
a separation chamber having at least one fluid exchange port and a volume defined by a first wall, a second wall, an end edge wall, and a plurality of side edge walls; and
the separation chamber having an upper fluid outlet, the upper fluid outlet being in fluid communication with a pump.

17. The system of claim 16, further comprising a pump for pumping fluid from the separation chamber to a spray head.

18. The system of claim 16, further comprising a pump for pumping fluid from the separation chamber directed at a window of the parts cleaner.

19. An apparatus, comprising:
a parts washer;
a separation chamber associated with the parts washer, the separation chamber having a volume defined by at least one wall, the wall being conically shaped, the separation chamber having a fluid outlet, the fluid outlet being in fluid communication with a pump; and
the conically shaped wall terminating into at least one fluid exchange port.
